(19) United States
(12) Patent Application Publication
(10) Pub. No.: US 2007/0089843 A1
(43) Pub. Date: Apr. 26, 2007

(54) Door drive with an arrester

(76) Inventor: Michael Hoermann, Halle/Westf. (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/584,237

(22) Filed: Oct. 20, 2006

(30) Foreign Application Priority Data
Oct. 26, 2005 (DE) 20 2005 016 816.5

(51) Int. Cl. E05D 15/00

(52) U.S. Cl. 160/201

(57) ABSTRACT

The present disclosure relates to a door drive comprising a guide carriage which is connected to the door, is arranged movably in a guide rail, is connected to the drive device of the door drive via a drive means and comprising an arrester consisting of an arresting member held at the guide carriage and being movable between a release position and an arrested position, with it engaging at an arresting rail in a shape-matched or force-transmitting manner in the arrested position. In accordance with the present disclosure, the arresting member is made as a two-arm lever which is pivotable around a pivot point and one end of the lever is made as a pawl, whereas a follower roll is arranged at the other end and the follower roll is guided along a cam section so that the pawl dips regularly into recesses provided sequentially in the arresting rail on a regular door movement.

### CROSS REFERENCE TO RELATED APPLICATION

This application claims priority to German Utility Model Application Serial No. DE 20 2005 016 816.5, filed Oct. 26, 2005, which is incorporated by reference in its entirety for all purposes.

### FIELD

The present disclosure relates to a door drive comprising an arrester.

### BACKGROUND AND SUMMARY

The present disclosure relates to drives for door leaves, with generally all building closing devices being understood as a door leaf which has door closing leaves which are movable in total in the vertical direction between the open position and the closed position such as, for example, one-part up and over doors which can be moved overhead, doors with a roll-up curtain, a so-called roller curtain, as the door leaf, sectional roll-up doors and the like. These doors must be secured against them being able to move into their closed position in an uncontrolled and accelerated manner on the occurrence of a defect in their suspension, in particular due to a break of the associated counterweight device, because there is above all thereby a risk for persons and goods located thereunder.

Arresters have become known which have different designs depending on the type of door or on the suspension of the door leaf. Arresters have thus become known, for example, which are triggered in dependence on the centrifugal force and which monitor the rotating speed of a shaft as to whether it remains below a desired value determined by the nominal operating state. Rotating speeds which go beyond this signify a crashing down of the door leaf and trigger the arrester.

An arrester of this type is shown, for example, in FIG. 1. A sectional door 10 is shown here schematically for the closing of a garage aperture 12, with the drive device not being shown here for reasons of simplicity. A rebound strap 14, which is wound on a corresponding shaft 16, runs parallel to the garage door drive. In the embodiment shown here, the rebound strap 14 is guided around a pulley block 18. A plan view of the strap 14 and a sectional view through the band 14 are likewise shown in FIG. 1. It becomes clear from the sectional representation that the band 14 is guided in a C-shaped rail. The shaft 16, onto which the rebound strap is wound, is monitored for the maximum permitted rotating speed in the manner described in more detail above. The corresponding arresting mechanism can be designed here in a similar manner as with a restraint belt for motor vehicles. In a further attachment variant for the winding shaft 16 likewise shown in FIG. 1, said winding shaft is installed directly on the rear wall of the garage so that no pulley block 18 has to be provided here.

A generic door drive is known from DE 34 13 236 A1, which comprises a guide carriage which is movable in a guide rail, is in connection with the door, is in connection with the drive device of the door drive via a drive means and is equipped with an arrester consisting of an arresting member held at the guide carriage. The arresting member is movable between a release position and an arrested position, with it engaging in a shape-matched and force-transmitting manner at an arresting rail in the arrested position. In this already known door drive with an arrester, for the case of the closing movement of the door leaf, a force is introduced in the closing movement direction of the door leaf via a dog part which is fastened to the driving member, with the pusher part being located in a door closing position under said force in which it holds the arresting member in its release position. In this position of the arresting member, the door leaf can be moved without impediment. If the counterweight device of the door leaf fails, the door leaf attempts to move into the closed position under its own weight. It accordingly accelerates its movement with respect to that of the drive member, with a dog part being displaced out of its door closing position in the direction of its door opening position relative to the door leaf and so to the guide carriage. The arresting member is thereby moved out of its release position into the arrested position in which the further movement of the door leaf is blocked. These circumstances do not only result during the closing procedure of the door leaf, but also on the failure of the counterweight device in the open position with a stationary drive.

It is the object of the present disclosure to further develop a door drive with an arrester such that the door can be reliably arrested on the failure of the associated counterweight device, with the arrester being made in a simple and functionally reliable manner.

This object is solved in accordance with the present disclosure by a door drive comprising a guide carriage which is connected to the door, arranged movably in a guide rail, and connected to the drive device of the door drive via a drive means. The door drive further comprises an arrester having an arresting member held at the guide carriage and being movable between a release position and an arrested position, with it engaging at an arresting rail in a shape-matched or force-transmitting manner in the arrested position, where the arresting member is made as a two-armed lever pivotable around a pivot point. One end of the lever is made as a pawl, whereas a follower roll is arranged at the other end. The follower roll is guided along a cam section such that the pawl dips regularly into recesses provided sequentially in the arresting rail on a regular door movement. At a usual opening and closing speed of the door, the follower roll can now follow the cam section and the pawl of the lever can dip into the corresponding recesses of the arresting rail or rise out of them again.

If an unforeseen problem now occurs, for example due to a disturbance in the counterweight device of the door, the pivot mechanism of the lever is too sluggish to follow the cam section. The end of the lever made as a pawl catches in this position with the boundary of the recess inside the arresting rail into which it is just dipping. On the opening of the door, the pawl is again moved away from the end of the recess and the follower roll of the lever can again lie on the cam section and thus again duly dip the two-arm lever made as an arresting member into the recesses provided in the arresting rail or pull it out of them again.

Various additional features may also be included to provide additional operation.

The cam section and the arresting rail can be made integrally. In this context, they are advantageously made as a sheet metal section, with one track of the sheet metal section forming the cam section and the track arranged next to this forming the arresting rail with the corresponding recesses.

The arresting rail and the cam section can be connected to the guide rail at the side. A guide rail made in C-profile shape as a rule can thus be retrofitted with an additional arresting rail and with a cam section by corresponding holders. In this variant, the arresting member can be arranged laterally on the guide carriage by means of a holding apparatus.

Alternatively, the arresting rail with the cam section can also be arranged inside the guide rail.

The follower roll is preferably pressed against the cam section via spring force. With a corresponding dimensioning of the two-arm lever, however, a corresponding lying of the follower roll on the cam section can also be achieved by gravity.

### BRIEF DESCRIPTION OF THE FIGURES

Further features, details and advantages of the present disclosure result from embodiments shown in the drawing. There are shown:

FIG. 1 shows a schematic representation of a door comprising an arrester in accordance with the prior art;

FIG. 2 shows a sectional representation through a part of a door drive with an arrester in accordance with a first embodiment of the present disclosure;

FIG. 3 shows a sectional representation along the sectional line III-III in FIG. 2;

FIG. 4 shows the embodiment of FIG. 2 in which the arrester and the corresponding attached parts are shown in the dismantled state;

FIG. 5 shows a partly sectioned side representation of a guide carriage of a door drive with an integrated arrester in accordance with another embodiment of the present disclosure;

FIG. 6 shows a cross-section through the carriage of FIG. 5;

FIG. 7 shows a side representation partly sectioned, of a guide carriage of a door drive in accordance with the present disclosure in accordance with a further embodiment of the present disclosure;

FIG. 8 shows plan views, side views and cross-sections of the arresting rail with cam section;

FIGS. 9A, 9B, and 9C show a carriage with an arrester of FIG. 5 in three different functional positions;

FIG. 10 shows a partial sectional representation through a part of a door drive with arrester in accordance with a further embodiment of the present disclosure;

FIG. 11 shows a representation of the kinematics of the arrester in accordance with the embodiment of FIG. 10;

FIGS. 12A, 12B, and 12C show the guide carriage of FIG. 10 with an arrester in place;

FIGS. 13A and 13B show a holding device for the arrester in accordance with the embodiment of FIG. 10, said holding device being separable from the guide carriage; and

FIGS. 14A-16 show various representations for holding systems for the U-shaped arresting rail in accordance with the embodiment of FIG. 10.

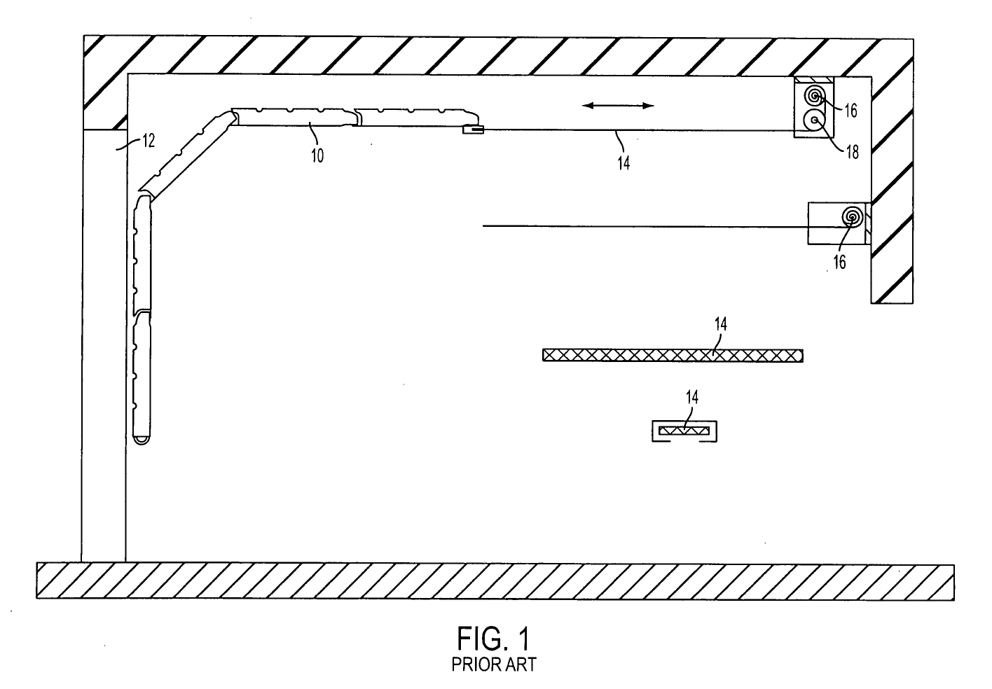

### DETAILED DESCRIPTION

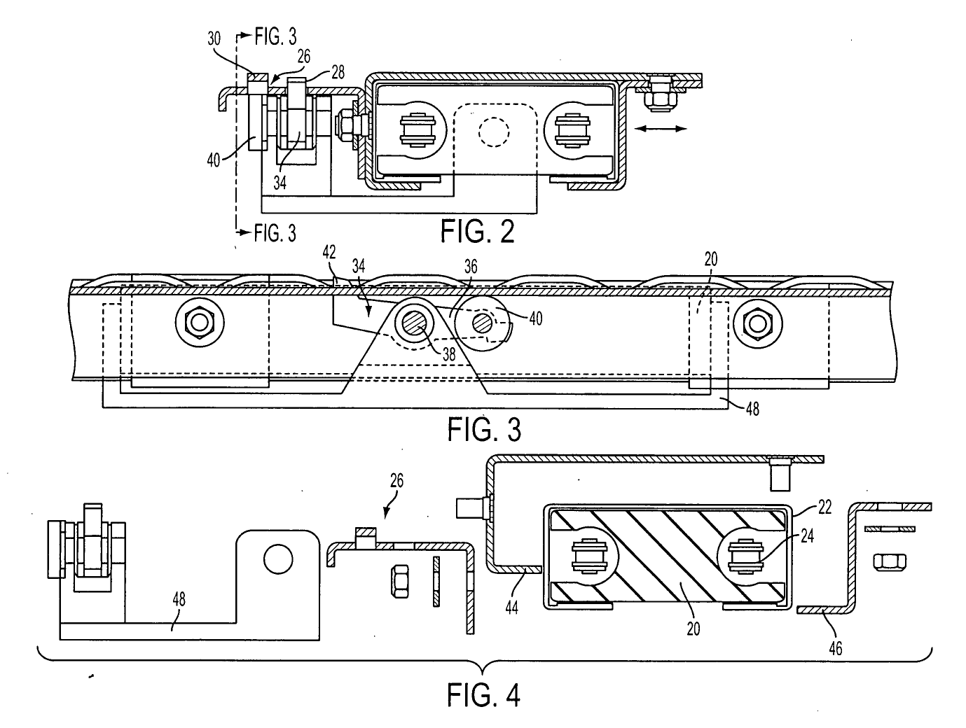

In the embodiments of FIGS. 2 to 4, a guide carriage 20 of known design is guided in a guide rail 22. The guide rail 22 is formed by a C-shaped section. The guide carriage 20 is moved to and fro along the guide rail by a chain serving as a drive means via a drive device not shown in any more detail here. The guide carriage can hereby open or close the door, to which the guide carriage is connected via corresponding linkages, in a manner likewise not shown in any more detail.

A sheet metal section 26 is arranged next to the guide rail 22 and has an arresting rail 28, on the one hand, and a cam section 30, on the other hand. Generally, a plan view and corresponding sectional representations of the sheet metal section are shown in FIG. 8. It becomes clear there that the arresting rail 28 has corresponding recesses 32 and that the cam section 30 is made in wave form.

An arresting member 34, which is made as a two-arm lever 36, cooperates with the arresting rail 28. The two-arm lever 36 can be pivoted around a pivot point 38. A follower roll 40 is arranged on the one side of the two-arm lever 36, whereas the other end of the two-arm lever 36 is made as a pawl 42. In this connection, the follower roll 40 is arranged laterally offset to the pawl 42 so that it can cooperate with the cam section 30 arranged next to the arresting rail 28.

It becomes clear with reference to FIG. 4 that the sheet metal section 26 can be subsequently attached to the guide rail 22 with the aid of bent metal sheets 44 and 46 which can be screwed to one another such that they encompass the guide rail 22. For this purpose, the sheet metal section of the embodiment in accordance with FIGS. 2 to 4 is made as an angled sheet metal section, as shown in FIG. 4, since it can thus be simply screwed to the bent metal sheet 44. The two-arm lever 36 forming the arresting member 34 is screwed to the carriage 20 by means of a sheet metal carrier 48. In this connection, the sheet metal carrier 48 is in each case adapted to the length of the guide carriage 20 and is connected thereto via its bent over ends at the front and rear part of the guide carriage 20.

The variant of the arrester shown in FIGS. 2 to 4 can thus be retrofitted to a door drive in a simple manner.

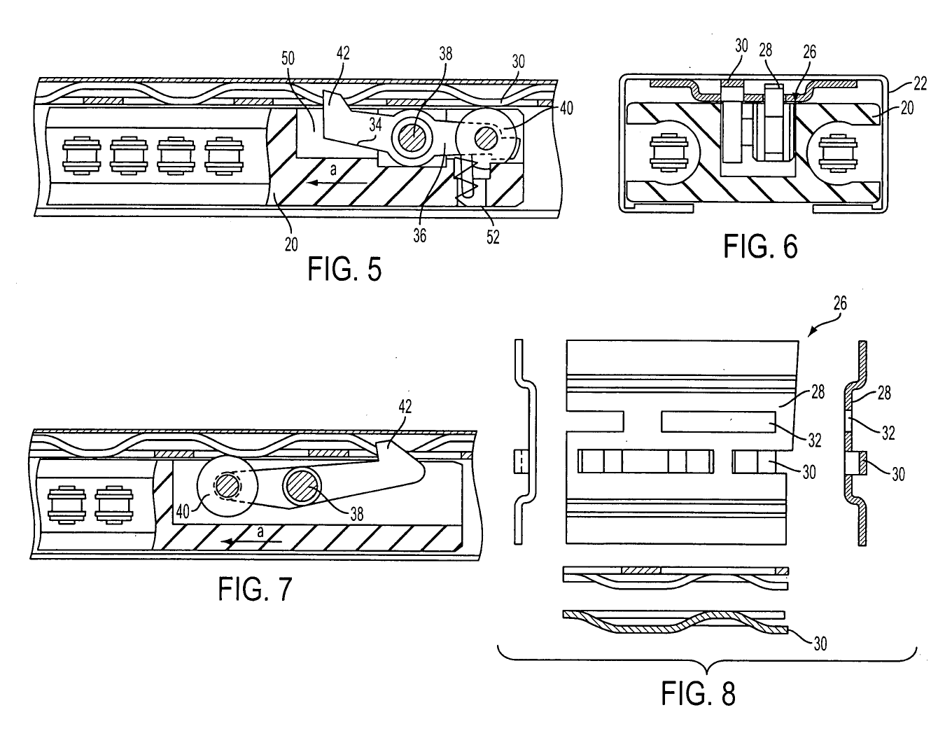

An alternative aspect of the arrester is shown in FIGS. 5 and 6. Here, the sheet metal section 26 is integrated with the cam section 30 and the arresting rail 28 inside the guide rail 22. For this purpose, the guide rail 22 is made somewhat higher than that in accordance with the variant of FIGS. 2 to 4. The carriage 20, which has a substantially conventional structure, extends below the sheet metal section 26. However, the guide carriage 20 accepts the arresting member 34 in a corresponding recess 50, said arresting member also being formed in this variant as a two-arm lever 36 with a follower roll 40 and a pawl 42. The follower roll 40 rolls along the cam section 30 in the same way as explained with reference to the variant of FIGS. 2 to 4. In this arrangement shown in FIG. 5, the direction “door closed” is shown by the arrow a. The pawl 42 therefore lies in front of the follower roll 40 in this direction with respect to the pivot point 38.

In the embodiment of FIG. 7, an alternative aspect of the present disclosure is shown in which the corresponding follower roll 40 lies in front of the pawl 42 with respect to the pivot point 38. Otherwise, this variant is essentially the same as that in accordance with FIGS. 5 and 6. In the variant in accordance with FIG. 5, the follower roll 40 is pressed into contact with the cam section 30 via a spring 52 indicated here. The follower roll 40 can thus follow the wave movement of the cam section. Instead of the spring 52, the weight distribution of the two-arm lever can also be selected such that the follower roll 40 is moved toward the cam section due to the heavier lever part.

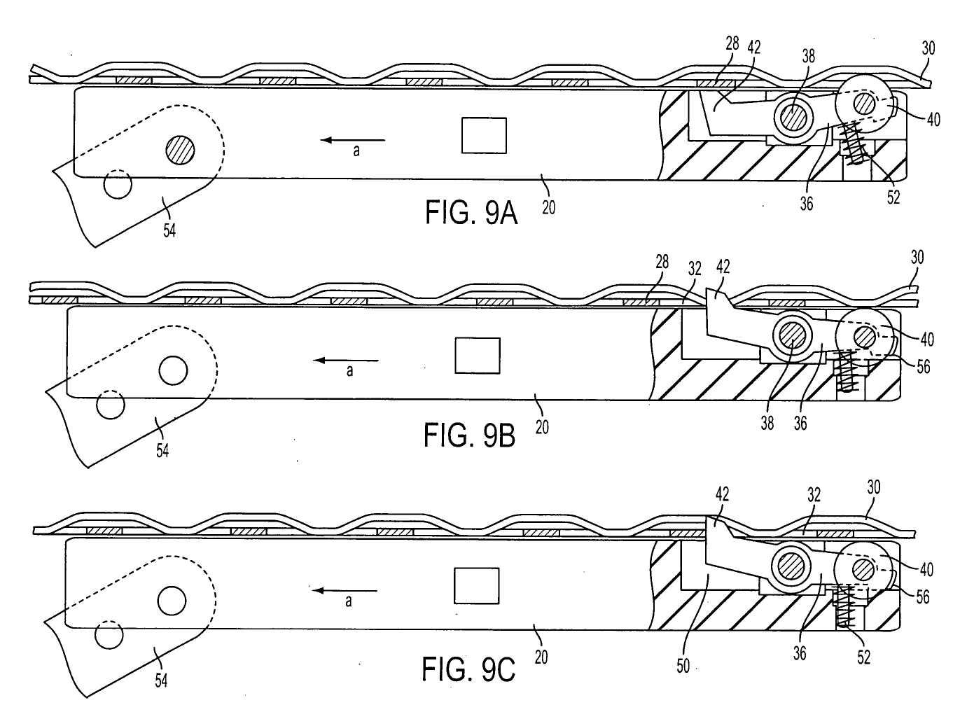

The working mechanism of the arrester can be explained with reference to the FIGS. 9A, 9B and 9C. In FIG. 9A, the follower roll 40 contacts the cam section 30, with the follower roll 40 having just reached a wave trough of the cam section 30. The two-arm lever 36 is hereby moved around the pivot point 38 such that the pawl 42 is positioned outside the arresting rail 28. In this context, the follower roll 40 is held in contact with the cam section 30 via the spring 52. In FIG. 9B, the follower roll 40 is shown in contact with a wave peak of the cam section 30. By corresponding pivoting of the two-arm lever 36 around the pivot point 38, the pawl 42 in this position dips into the recess 32 inside the arresting rail 28. Since the cam section 30 extends over the total length of the guide rail, the pawl 42 therefore moves regularly into the sequentially arranged recesses 32 and is again pulled out of them depending on whether the follower roll 40 is following a wave peak or a wave trough of the cam section 30.

If the door balance device is now defective or if the connection to this door balance device has been destroyed, the door moves in the direction of the position “door closed” (arrow direction a) with a high speed due to its own weight. With a correspondingly accelerated movement of the guide carriage 20 connected to the door via the linkage 54, the follower roll 40 can no longer follow the wave movement of the cam section 30 so that the pawl 42 can no longer be pulled out of the recess 32 in good time. The pawl 42 thereby hooks with the front end of the recess 32, whereby the downward movement of the door is stopped. On the moving of the pawl 42 onto the edge of the recess 32, an abutment 56, which is arranged in the region of the follower roll 40 at the two-arm lever 36, is supported on the base of the recess 50 provided in the carriage 20, as shown in FIG. 9C.

If the door is now moved upwardly again against the arrow direction a, the pawl 42 again comes out of engagement with the edge of the recess 32 so that the follower roll 40 again enters into contact with the cam section 30 due to the spring force of the spring 52 and thus again ensures the regular dipping of the pawl 42 into and out of the recess 32.

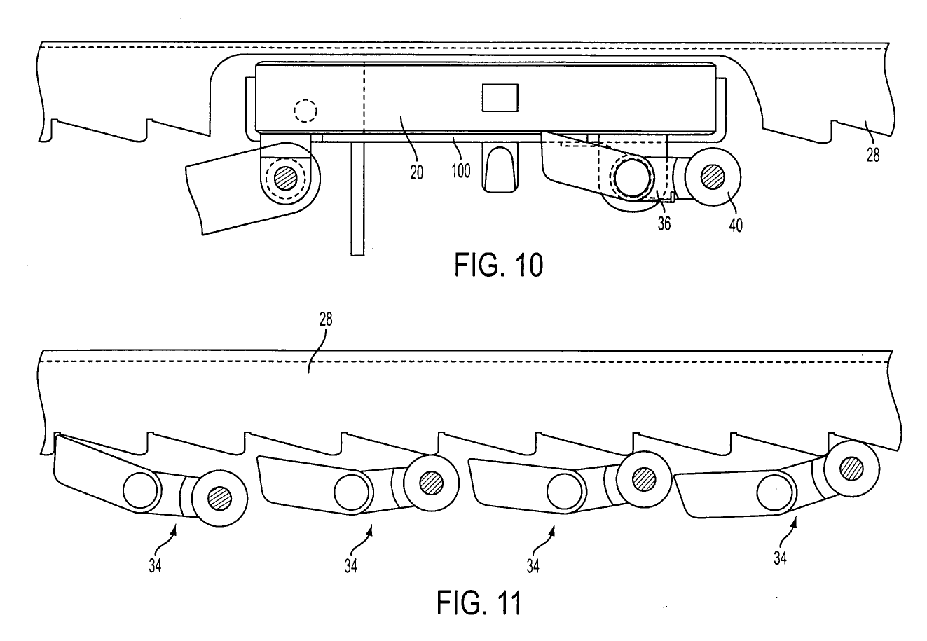

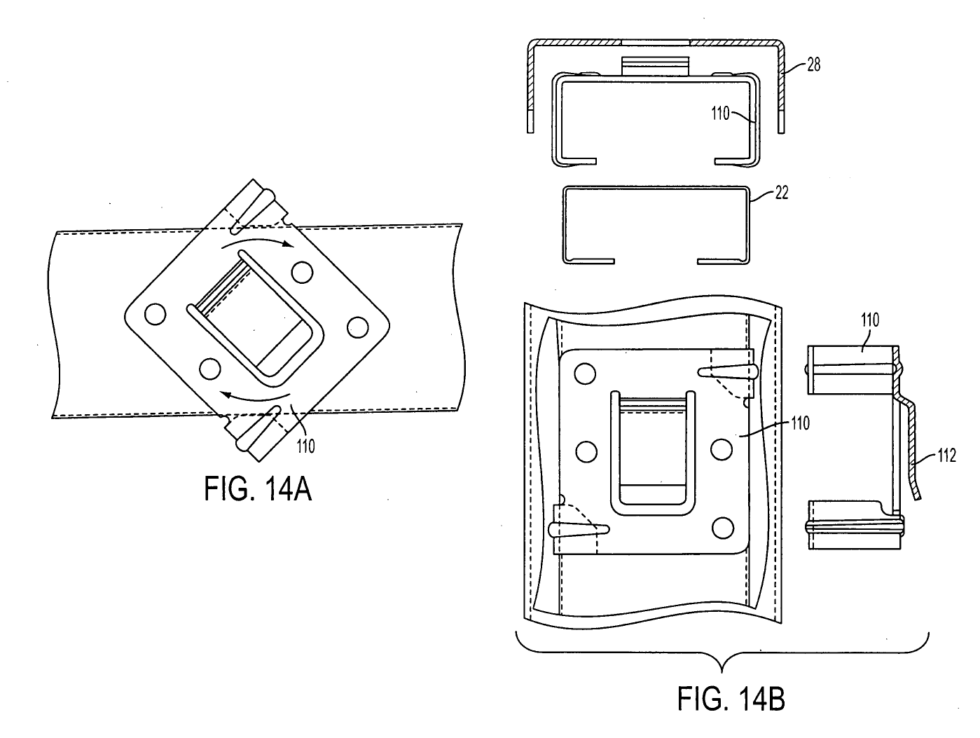

An alternative embodiment of the present disclosure is shown in FIGS. 10 to 15. This again, as shown in FIG. 10, has a guide carriage 20 which is guided in a guide rail 22 such as can be seen from FIG. 14B. For reasons of simplicity, it is not shown in the cut-away region of FIG. 10.

In the embodiment shown here, a holding apparatus 100 is connected to the guide carriage 20 and receives the two-arm lever 36 with its follower roll 40.

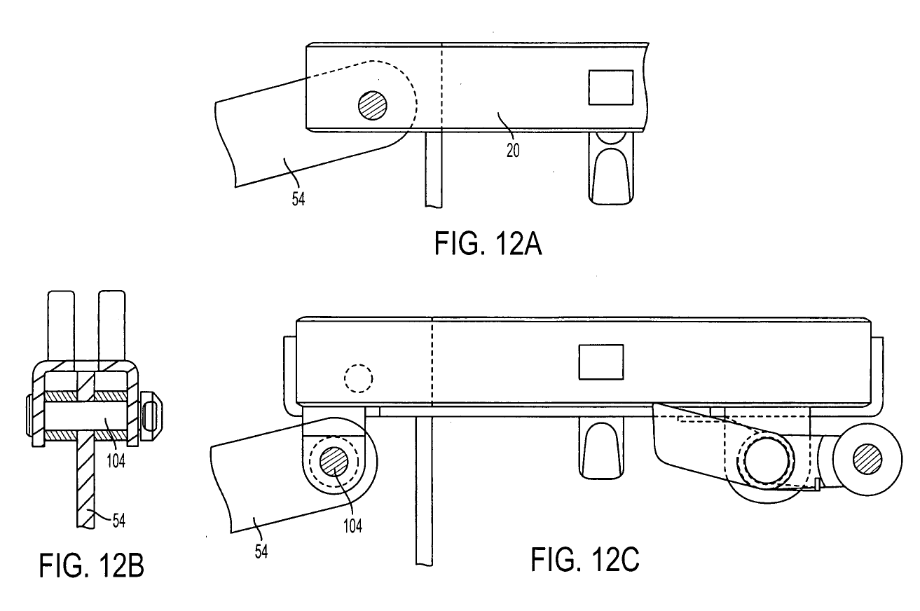

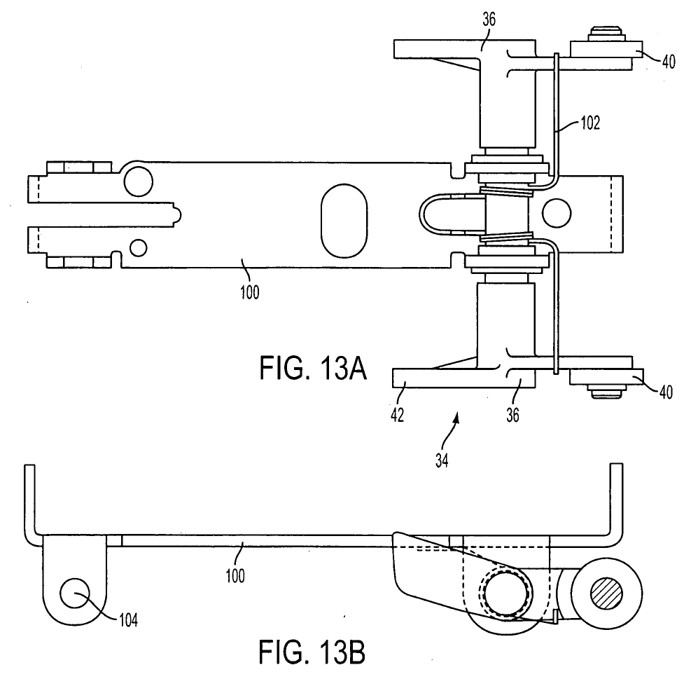

The design of the holding apparatus 100 results in plan view and in a side view from FIGS. 13A and 13B respectively. The holding apparatus 100 can be separated from the guide carriage. As in particular results from the plan view in accordance with FIG. 13A, the two-arm lever 36 is guided in double fashion in this embodiment, that is in each case at both sides of the guide carriage 20 in the installed state. The two-arm levers 36 are loaded correspondingly by a spring 102. This holding apparatus with the two-arm lever 26 which is pivotable around the pivot point 38 and has a follower roll 40 and a pawl 42 can be retrofitted via the holding apparatus 100 to a conventional structure guide carriage 20 such as is shown in FIG. 12A. For this purpose, the linkage 54, which is rotatably connected to the carriage, as shown in FIGS. 12A and 12C, is displaced away from this pivot point to a new pivot point 104 at the holding apparatus 100.

The two lateral arresting members 34 each cooperate with arresting rails 28 likewise arranged at the side, as FIG. 11 shows. The arresting rail 28 in this variant simultaneously forms the cam section on which the follower roll 40 rolls off. The movement sequence, which is run through during the movement of the guide carriage 20, can be seen in the sequence in accordance with FIG. 11, in which the different positions of the arresting member 34 are shown. The arresting rail 28 in accordance with the present variant is made in U shape, as can be seen from FIG. 14. This means that the sawtooth-like sections of the arresting rail 28 are each arranged to the side of the guide rail 22 and can thus cooperate with the lateral arresting members 34. In order also to permit a retrofitting of a conventional guide rail with the arresting rail 28 here, holding clamps 110 are provided such as are shown in FIG. 14B. These holding clamps 114 can be clampingly connected to the guide rail 22 via a rotary movement (cf. FIG. 14A).

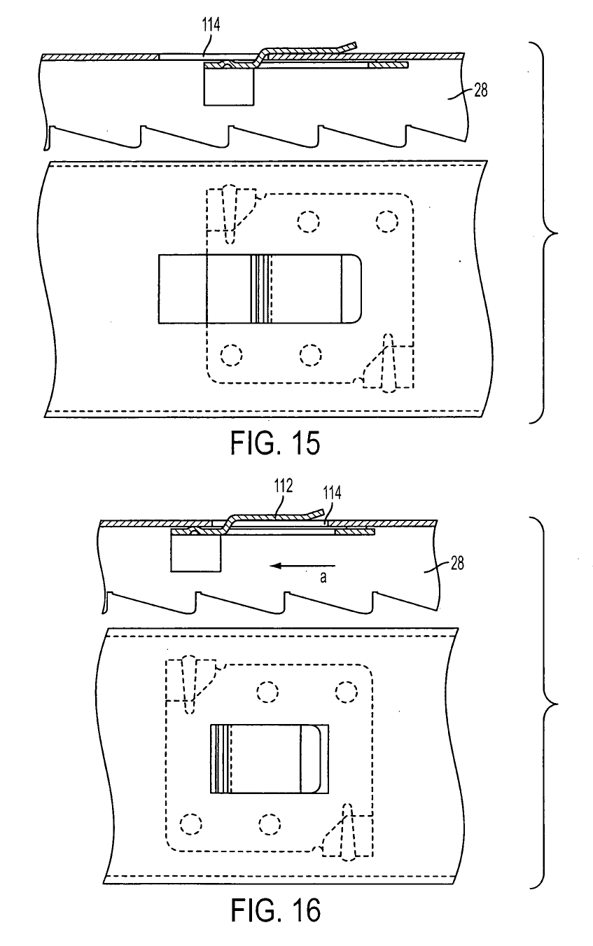

The clamps 110 have a lug 112 rising upwardly under which the U-shaped section of the arresting rail 28 can be pushed, as shown in FIG. 15. To be able to push the U-shaped section with the arresting rails 28 under the lug 112, the U-shaped arresting rail 28 has a recess 114. It is shown in FIG. 16 how the lug 112 is pushed through the opening 114 so that the U-shaped section 28 can be pushed into the clamped position in accordance with FIG. 15 after movement of the U-shaped section 28 in the arrow direction a.

The arrester in accordance with the present disclosure in accordance with this embodiment can thus be retrofitted on a commercially available garage door drive.

1. A door drive comprising a guide carriage which is connected to the door, is arranged movably in a guide rail, is connected to the drive device of the door drive via a drive means and comprising:
an arrester having an arresting member held at the guide carriage and being movable between a release position and an arrested position, with it engaging at an arresting rail in a shape-matched or force-transmitting manner in the arrested position, where the arresting member is made as a two-arm lever which is pivotable around a pivot point; where one end of the lever is made as a pawl, whereas a follower roll is arranged at another end; and where the follower roll is guided along a cam section so that the pawl dips regularly into recesses provided sequentially in the arresting rail on a regular door movement.

2. A door drive in accordance with claim 1, wherein the cam section and the arresting rail are made in one piece.

3. A door drive in accordance with claim 2, wherein the arresting rail and the cam section are made as a sheet metal section.

4. A door drive in accordance with claim 1, wherein the arresting rail and the cam section are connectable to the guide rail at the side.

5. A door drive in accordance with claim 4, wherein the arresting member made as a lever is arranged laterally at the guide carriage by a holding apparatus.

6. A door drive in accordance with claim 1, wherein the arresting member made as a lever is arranged below and in parallel to the guide carriage by a holding apparatus.

7. A door drive in accordance with claim 1, wherein the arresting rail and the cam section are arranged inside the guide rail.

8. A door drive in accordance with claim 1, wherein the follower roll is pressed against the cam section via spring force.

9. A door drive in accordance with claim 5, wherein the guide carriage and the arresting member arranged at a holding apparatus are separate components.

10. A door drive in accordance with claim 9, wherein the holding apparatus accepting the arresting member encompasses the guide carriage in the manner of a clamp from below, with two two-arm levers forming the arresting member each being arranged to the side of the guide carriage and cooperating with the arresting rail surrounding the running rail in a U-shape.

11. A door drive for a door, comprising:
a drive device;
a guide rail;
a guide carriage coupled to the door, the guide carriage arranged movably in the guide rail and coupled to the drive device;
an arrester having an arresting member held at the guide carriage and being movable between a release position and an arrested position, the arrestor engaging at an arresting rail in a shape-matched or force-transmitting manner in the arrested position, where the arresting member is as a two-arm lever which is pivotable around a pivot point, the arrestor shaped as a pawl at a first end and having a follower roll at a second end; and where the follower roll is guided along a cam section so that the pawl dips regularly into recesses provided sequentially in the arresting rail on a regular door movement.

12. A door drive in accordance with claim 11, wherein the cam section and the arresting rail are a single piece.

13. A door drive in accordance with claim 12, wherein the arresting rail and the cam section comprise a sheet metal section.

14. A door drive in accordance with claim 11, wherein the arresting rail and the cam section are connectable to the guide rail at the side.

15. A door drive in accordance with claim 14, wherein the arresting member is arranged laterally at the guide carriage by a holding apparatus.

16. A door drive in accordance with claim 11, wherein the arresting member is arranged below and in parallel to the guide carriage by a holding apparatus.

17. A door drive in accordance with claim 1, wherein the arresting rail and the cam section are arranged inside the guide rail.

18. A door drive in accordance with claim 17, wherein the follower roll is pressed against the cam section via spring force.

19. A door drive in accordance with claim 15, wherein the guide carriage and the arresting member arranged at a holding apparatus are separate components.

20. A door drive in accordance with claim 19, wherein the holding apparatus accepting the arresting member encompasses the guide carriage in the manner of a clamp from below, with two two-arm levers forming the arresting member each being arranged to the side of the guide carriage and cooperating with the arresting rail surrounding the running rail in a U-shape.
